(19) United States
(12) Patent Application Publication
(10) Pub. No.: US 2017/0122564 A1
(43) Pub. Date: May 4, 2017

(54) FUEL NOZZLE WALL SPACER FOR GAS TURBINE ENGINE

(71) Applicant: General Electric Company, Schenectady, NY (US)

(72) Inventors: John Michael Cadman, Mason, OH (US); Ronald D. Redden, Foster, KY (US); Brian Matthias Schaldach, Cincinnati, OH (US); Randy Joseph Tobe, Lebanon, OH (US)

(21) Appl. No.: 14/926,333

(22) Filed: Oct. 29, 2015

(51) Int. Cl. F23R 3/28; F02C 3/04

(52) U.S. Cl. CPC F23R 3/28; F02C 3/04; F05D 2220/36

(57) ABSTRACT

A fuel nozzle configured to channel fluid towards a combustion chamber defined within a gas turbine engine is provided. The fuel nozzle includes a first hollow tube and a second hollow tube concentrically aligned with the first hollow tube and defining a gap therebetween. The first hollow tube has a central passageway configured to channel fuel therethrough. The second hollow tube is typically in contact with compressor discharge gases and is therefore at a higher temperature than the first hollow tube. Thus, the fuel nozzle includes at least one detached or free spacer retained within the gap so as to minimize heat transfer between the first and second hollow tubes. Accordingly, the detached spacer(s) is un-joined or free within the gap where thermal energy transfer is disadvantageous.

### GOVERNMENT SUPPORT CLAUSE

This invention was made with government support under FA8650-09-D-2922 awarded by the United States Department of the Air Force. The government has certain rights in this invention.

### FIELD OF THE INVENTION

The present subject matter relates generally to fuel nozzles for gas turbine engines. More particularly, the present subject matter relates to a fuel nozzle wall or tube spacer for a gas turbine engine.

### BACKGROUND OF THE INVENTION

A gas turbine engine generally includes, in serial flow order, a compressor section, a combustion section, a turbine section and an exhaust section. In operation, air enters an inlet of the compressor section where one or more axial compressors progressively compress the air until it reaches the combustion section. Fuel is mixed with the compressed air and burned within the combustion section to provide combustion gases. The combustion gases are routed from the combustion section through a hot gas path defined within the turbine section and then exhausted from the turbine section via the exhaust section.

In particular configurations, the turbine section includes, in serial flow order, a high pressure (HP) turbine and a low pressure (LP) turbine. The HP turbine and the LP turbine each include various rotatable turbine components such as turbine rotor blades, rotor disks and retainers, and various stationary turbine components such as stator vanes or nozzles, turbine shrouds, and engine frames. The rotatable and stationary turbine components at least partially define the hot gas path through the turbine section. As the combustion gases flow through the hot gas path, thermal energy is transferred from the combustion gases to the rotatable and stationary turbine components.

Turbine engines also include one or more fuel nozzles for supplying fuel to the combustion section of the engine. Known fuel nozzle designs typically include one or more concentric tubes coaxially mounted so as to define one or more annular passages or conduits that allow for fluid to flow therethrough. Thus, the fuel can be introduced at the front end of a burner in a highly atomized spray from a fuel nozzle. Compressed air flows around the fuel nozzle and mixes with the fuel to form a fuel-air mixture, which is ignited by the burner. Thus, for typical fuel nozzles, the exterior tube is immersed in high temperature gas while the inner fuel tube must be maintained at a lower temperature. Elevated fuel temperatures can promote the formation of fuel-derived deposits that can unacceptably increase the total fuel nozzle flow restriction or change the flow velocity and/or jet shape.

In order to prevent the formation of unacceptable levels of fuel-derived deposits by maintaining a large thermal potential between the combustor gas and the fuel, fuel nozzles with high thermal resistance are required. Further, fuel nozzles must be able to withstand mechanical excitations during engine operation that require the transfer of mechanical loads through the body of the nozzle. In addition, in order to improve engine performance in aerospace applications, the fuel nozzle weight should be minimized.

Thus, modern fuel nozzles may have numerous, complex internal air and/or fuel conduits to create multiple and/or separate flame zones. Such fuel conduits may require heat shields from the internal air to prevent coking, and certain fuel nozzle components may have to be cooled and shielded from combustion gases. Still additional features may have to be provided in the fuel nozzle to promote heat transfer and cooling.

For example, one example fuel nozzle is described in U.S. Pat. No. 4,735,044 entitled “Dual Fuel Path Stem for a Gas Turbine Engine, filed on Nov. 25, 1980, which is hereby incorporated by reference in its entirety in the present application. More specifically, the fuel nozzle of the aforementioned patent includes a stem having two concentric tubes (e.g. an innermost primary tube and a secondary tube) inside an outer tube. Thus, the outer tube is preferably employed to provide structural support and thermal insulation to the inner tubes. Further, it is desirable to shield the secondary tube from the outer tube, as the outer tube is typically exposed to hot compressor discharge air. Thus, one means to provide such shielding is through the use of spacer wires periodically attached to the secondary tube. The primary tube is completely insulated by being completely inside the secondary tube and the secondary tube is not connected either to the primary tube or to the outer tube. As such, the secondary tube is permitted to “float” between the primary tube and the outer tube. The annular space defined between the secondary tube and the outer tube typically receives a portion of the fuel flow, which then functions to provide further insulation between the primary and secondary tubes, respectively. Thus, low thermal stresses are present in all three of the tubes because of the concentric structure as well as the internal insulation gaps that are provided.

The spacer wires described above are typically brazed or welded to the inner surface of at least one of the walls of the concentric tubes so as to retain the spacer wires in a predetermined location. The joined interface(s), however, can create issues for thermal conductivity. For example, continued exposure to high temperatures during turbine engine operations may induce thermal gradients and/or stresses in the conduits and fuel nozzle components which may damage the components and/or adversely affect operation of the nozzle.

Accordingly, the present disclosure is directed to a fuel nozzle that increases thermal resistance between the combustor gas and fuel while allowing the transfer of mechanical loads between adjacent structural components with a relatively small contribution to overall fuel nozzle weight.

### BRIEF DESCRIPTION OF THE INVENTION

Aspects and advantages of the invention will be set forth in part in the following description, or may be obvious from the description, or may be learned through practice of the invention.

In accordance with one aspect of the present disclosure, a fuel nozzle configured to channel fluid towards a combustion chamber defined within a gas turbine engine is provided. The fuel nozzle includes a first hollow tube and a second hollow tube configured with the first hollow tube and defining a gap therebetween. The first hollow tube has a central passageway configured to channel fuel therethrough. The second hollow tube is typically in contact with compressor discharge gases and is therefore at a higher temperature than the first hollow tube. Thus, the fuel nozzle includes at least one detached spacer retained within the gap so as to minimize heat transfer between the first and second hollow tubes.

More specifically, the detached spacer(s) is un-joined or free within the gap where thermal energy transfer is disadvantageous. As such, for heat to conduct through the detached spacer, it must travel through two or more contact interfaces, which significantly decreases the total thermal conductivity between the tubes. Thus, the detached spacer(s) provides heat shielding by reducing thermal energy transfer between the first and second hollow tubes. Accordingly, the spacers as described herein may be advantageous with various types of nozzles, including but not limited to fuel nozzle designs for lean burn/low NOx applications having complex geometries (e.g. non-uniform, non-concentric designs), as well as concentric tube fuel nozzles.

In another aspect, the present disclosure is directed to a fuel nozzle configured to channel fluid towards a combustion chamber defined within a gas turbine engine. The fuel nozzle includes a central hollow tube having a central passageway configured to channel fuel therethrough, a secondary hollow tube concentrically aligned with the central hollow tube configured to channel fuel therethrough, and an outer hollow tube concentrically aligned with the secondary hollow tube. The secondary hollow tube defines a first gap with the central hollow tube and the outer hollow tube defines a second gap with the secondary hollow tube. Further, the secondary hollow tube is at a higher temperature than the central hollow tube and the outer hollow tube is at a higher temperature than the secondary hollow tube. Thus, the fuel nozzle also includes at least one detached spacer retained within at least one of the first or second gaps so as to minimize heat transfer between the hollow tubes.

In yet another aspect, the present disclosure is directed to a combustor assembly for use with a gas turbine engine. The combustor assembly includes a combustion chamber and a fuel nozzle coupled with the combustion chamber. Further, the fuel nozzle includes, at least, a first hollow tube and a second hollow tube concentrically aligned with the first hollow tube and defining a gap therebetween. The first hollow tube defines a central passageway configured to channel fuel therethrough. The second hollow tube is typically in contact with compressor discharge gases and is therefore at a higher temperature than the first hollow tube. Thus, the fuel nozzle includes at least one detached spacer retained within the gap so as to minimize heat transfer between the first and second hollow tubes.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic cross-sectional view of one embodiment of a gas turbine engine according to the present disclosure;

FIG. 2 illustrates a perspective view of one embodiment of a fuel nozzle for a gas turbine engine according to the present disclosure;

FIG. 3 illustrates a cross-sectional view of one embodiment of a fuel nozzle for a gas turbine engine according to the present disclosure;

FIG. 4 illustrates a cross-sectional view of the fuel nozzle of FIG. 3 along line 4-4;

FIG. 5 illustrates a simplified, cross-sectional view of one embodiment of a fuel nozzle for a gas turbine engine according to the present disclosure;

FIG. 6 illustrates a cross-sectional view of the fuel nozzle of FIG. 5 along line 6-6;

FIG. 7 illustrates a partial, schematic diagram of one embodiment of a fuel nozzle for a gas turbine engine according to the present disclosure, particularly illustrating a detached spacer configured between first and second hollow tubes of the fuel nozzle;

FIG. 8 illustrates a simplified, cross-sectional view of another embodiment of a fuel nozzle for a gas turbine engine according to the present disclosure;

FIG. 9 illustrates a cross-sectional view of the fuel nozzle of FIG. 8 along line 9-9;

FIG. 10 illustrates a simplified, cross-sectional view of yet another embodiment of a fuel nozzle for a gas turbine engine according to the present disclosure;

FIG. 11 illustrates a cross-sectional view of the fuel nozzle of FIG. 10 along line 11-11; and

FIG. 12 illustrates a cross-sectional view of still another embodiment of a fuel nozzle for a gas turbine engine according to the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “rear” used in conjunction with “axial” or “axially” refers to a direction toward the engine nozzle, or a component being relatively closer to the engine nozzle as compared to another component. The terms “radial” or “radially” refer to a dimension extending between a center longitudinal axis of the engine and an outer engine circumference.

Generally, the present disclosure is directed to a fuel nozzle configured to channel fluid towards a combustion chamber defined within a gas turbine engine is provided. More specifically, the fuel nozzle includes, at least, first and second hollow tubes having a gap defined therebetween. Further, the first hollow tube has a central passageway configured to channel fuel therethrough, whereas the second hollow tube is typically in contact with high-temperature gases and is therefore at a higher temperature than the first hollow tube. Thus, the fuel nozzle also includes at least one detached or free spacer retained within the gap so as to minimize heat transfer between the first and second hollow tubes. Accordingly, the detached spacer(s) is un-joined or free within the gap where thermal energy transfer is disadvantageous. As such, for heat to conduct through the detached spacer(s), it must travel through two or more contact interfaces, which significantly decreases the total thermal conductivity between the hollow tubes. Thus, the detached spacer(s) provides heat shielding by reducing thermal energy transfer between the first and second hollow tubes. Accordingly, the detached spacer(s) as described herein are useful for multiple types of nozzles, including, e.g. fuel nozzle designs for lean burn/low NOx applications having complex geometries (e.g. non-uniform, non-concentric designs), as well as concentric tube fuel nozzles.

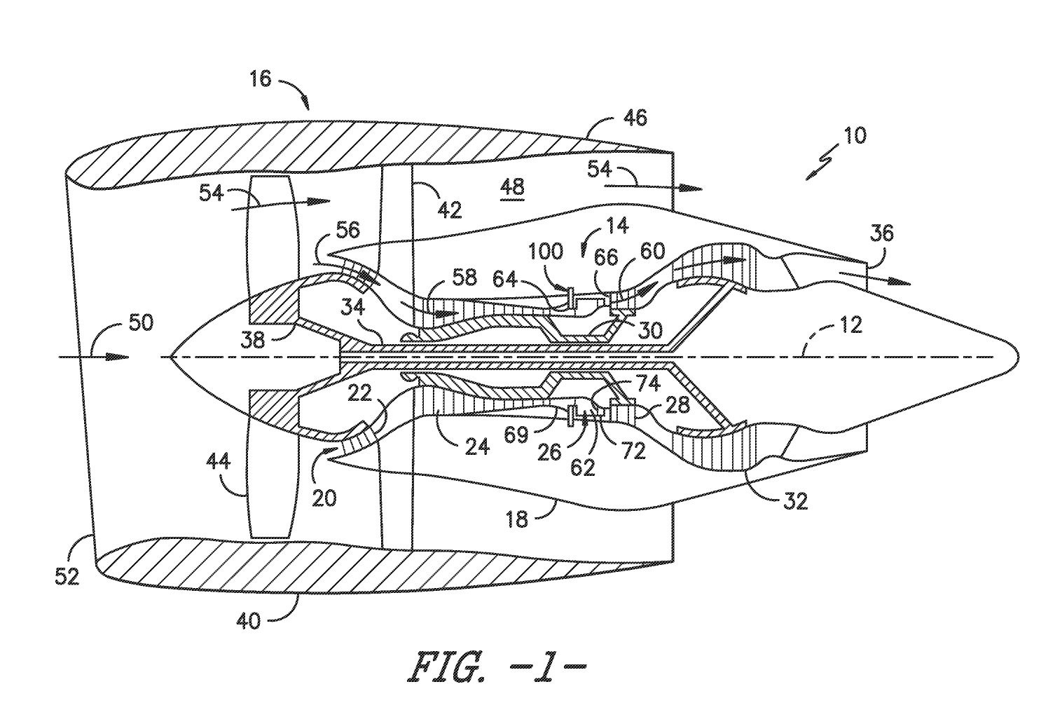

Referring now to the drawings, FIG. 1 illustrates a schematic cross-sectional view of one embodiment of a gas turbine engine 10 (high-bypass type) incorporating an exemplary fuel nozzle 100 according to the present disclosure. As shown, the gas turbine engine 10 has an axial longitudinal centerline axis 12 therethrough for reference purposes. Further, as shown, the gas turbine engine 10 preferably includes a core gas turbine engine generally identified by numeral 14 and a fan section 16 positioned upstream thereof. The core engine 14 typically includes a generally tubular outer casing 18 that defines an annular inlet 20. The outer casing 18 further encloses and supports a booster 22 for raising the pressure of the air that enters core engine 14 to a first pressure level. A high pressure, multi-stage, axial-flow compressor 24 receives pressurized air from the booster 22 and further increases the pressure of the air. The pressurized air flows to a combustor 26, where fuel is injected into the pressurized air stream and ignited to raise the temperature and energy level of the pressurized air. The high energy combustion products flow from the combustor 26 to a first (high pressure) turbine 28 for driving the high pressure compressor 24 through a first (high pressure) drive shaft 30, and then to a second (low pressure) turbine 32 for driving the booster 22 and the fan section 16 through a second (low pressure) drive shaft 34 that is coaxial with the first drive shaft 30. After driving each of the turbines 28 and 32, the combustion products leave the core engine 14 through an exhaust nozzle 36 to provide at least a portion of the jet propulsive thrust of the engine 10.

The fan section 16 includes a rotatable, axial-flow fan rotor 38 that is surrounded by an annular fan casing 40. It will be appreciated that fan casing 40 is supported from the core engine 14 by a plurality of substantially radially-extending, circumferentially-spaced outlet guide vanes 42. In this way, the fan casing 40 encloses the fan rotor 38 and the fan rotor blades 44. The downstream section 46 of the fan casing 40 extends over an outer portion of the core engine 14 to define a secondary, or bypass, airflow conduit 48 that provides additional jet propulsive thrust.

From a flow standpoint, it will be appreciated that an initial airflow, represented by arrow 50, enters the gas turbine engine 10 through an inlet 52 to the fan casing 40. The airflow passes through the fan blades 44 and splits into a first air flow (represented by arrow 54) that moves through the conduit 48 and a second air flow (represented by arrow 56) which enters the booster 22.

The pressure of the second compressed airflow 56 is increased and enters the high pressure compressor 24, as represented by arrow 58. After mixing with fuel and being combusted in the combustor 26, the combustion products 60 exit the combustor 26 and flow through the first turbine 28. The combustion products 60 then flow through the second turbine 32 and exit the exhaust nozzle 36 to provide at least a portion of the thrust for the gas turbine engine 10.

Still referring to FIG. 1, the combustor 26 includes an annular combustion chamber 62 that is coaxial with the longitudinal centerline axis 12, as well as an inlet 64 and an outlet 66. As noted above, the combustor 26 receives an annular stream of pressurized air from a high pressure compressor discharge outlet 69. A portion of this compressor discharge air flows into a mixer (not shown). Fuel is injected from a fuel nozzle 100 to mix with the air and form a fuel-air mixture that is provided to the combustion chamber 62 for combustion. Ignition of the fuel-air mixture is accomplished by a suitable igniter, and the resulting combustion gases 60 flow in an axial direction toward and into an annular, first stage turbine nozzle 72. The nozzle 72 is defined by an annular flow channel that includes a plurality of radially-extending, circumferentially-spaced nozzle vanes 74 that turn the gases so that they flow angularly and impinge upon the first stage turbine blades of the first turbine 28. As shown in FIG. 1, the first turbine 28 preferably rotates the high-pressure compressor 24 via the first drive shaft 30, whereas the low-pressure turbine 32 preferably drives the booster 22 and the fan rotor 38 via the second drive shaft 34.

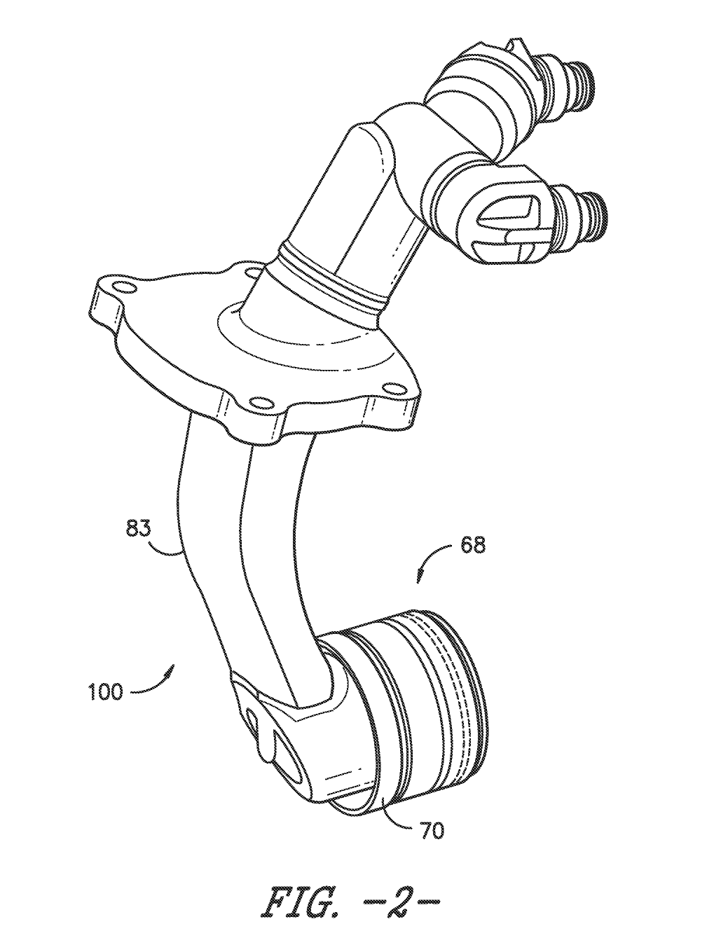

The combustion chamber 62 is housed within the engine outer casing 18. Fuel is supplied into the combustion chamber 62 by one or more fuel nozzles 100, such as for example shown in FIGS. 1-12. Liquid fuel is transported through conduits 80 or passageways within a stem 83, such as, for example, shown in FIGS. 2 and 3, to the fuel nozzle tip assembly 68. The fuel supply conduits 80 may be located within the stem 83 and coupled to a fuel distributor tip 70. More specifically, as shown in FIGS. 3-12, the fuel nozzle 100 may include, at least, a first or central hollow tube 102 and a second, outer hollow tube 104 configured with the first hollow tube 102. For example, in the illustrated embodiment, the first and second tubes 102, 104 may be concentrically aligned. However, in alternative embodiments, the fuel nozzle 100 may have any other suitable design including non-uniform and non-concentric tubes.

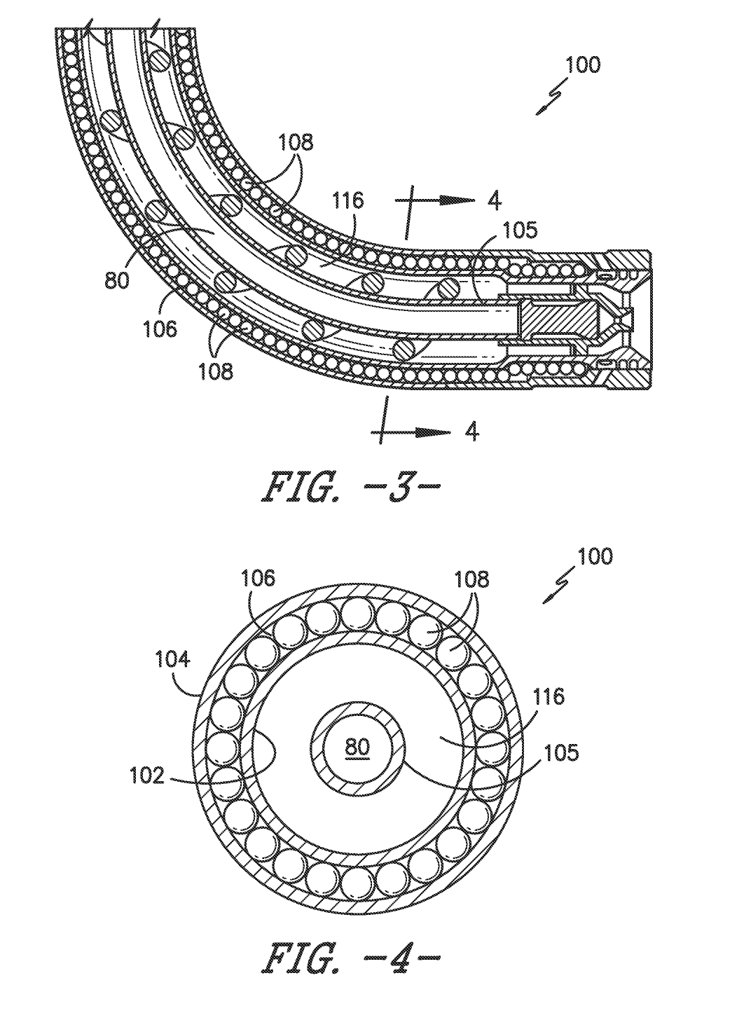

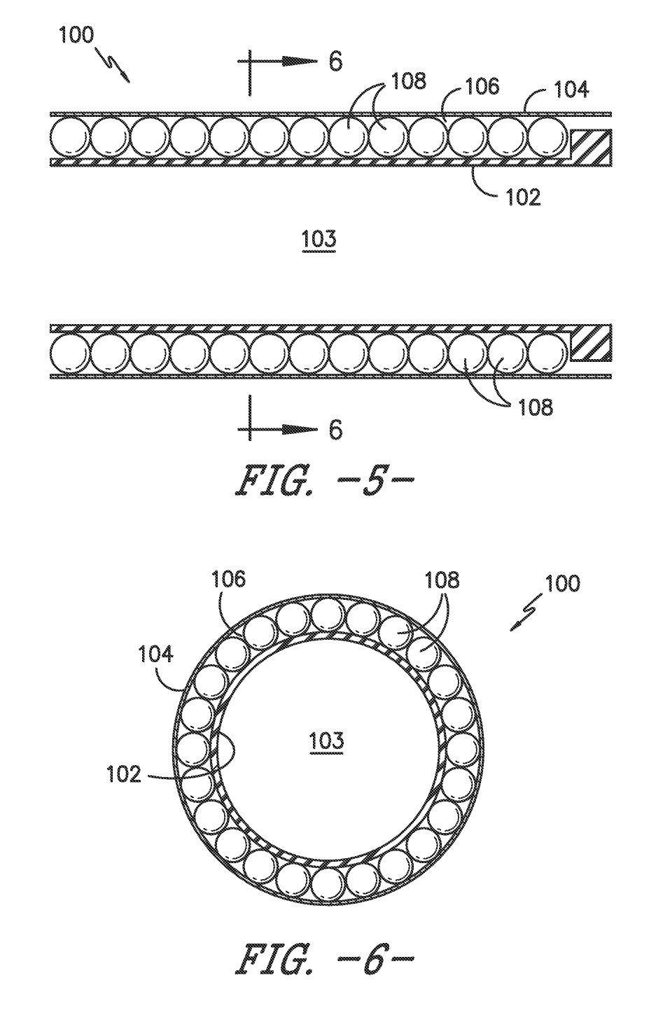

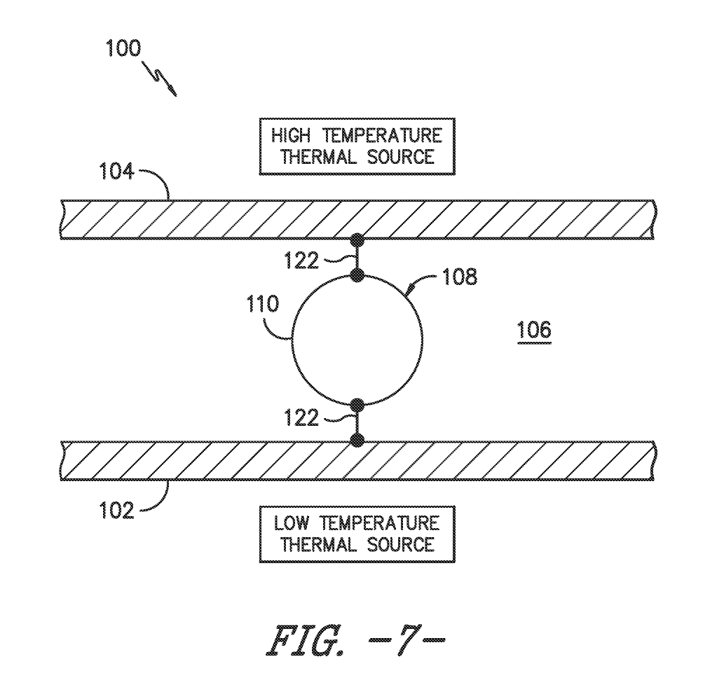

As shown, the first hollow tube 102 typically has a central passageway 103 configured to channel fuel therethrough. Further, as shown in FIG. 7, the outer hollow tube 104 is typically in contact with a high temperature thermal source (e.g. compressor discharge gases) and is therefore at a higher temperature than the first hollow tube 102 that contacts the fuel. In additional embodiments, as shown in FIGS. 3 and 4, the fuel nozzle 100 may also include a third hollow tube 105 concentrically aligned with the first and second hollow tubes 102, 104. In addition, as shown in FIGS. 5, 7, 8, 10, and 12, the hollow tubes 102, 104, 105 may be oriented substantially linearly with respect to each other. Although the figures illustrate fuel nozzles having two or three concentric tubes, it should also be understood that fuel nozzles according to the present disclosure may also include more than three concentric tubes.

In addition, as shown in the figures, the hollow tubes 102, 104, 105 generally define at least one gap 106 therebetween. For example, as shown in FIGS. 3 and 4, the second outer tube 104 defines a first annular gap 106 with the first hollow tube 102. Further, the first hollow tube 102 defines a second annular gap 116 with the third hollow tube 105. Thus, as shown, the fuel nozzle 100 may include at least one detached spacer 108 retained within either or both of the annular gaps 106, 116. More specifically, as shown in FIG. 7, the detached spacer(s) 108 as described herein may be free within the gap 106, which generally means that the spacer(s) 108 is not joined or secured to the inner surfaces of the tubes 102, 104, where thermal energy transfer is disadvantageous. Thus, as shown in FIG. 7, for heat to conduct through the detached spacer 108, heat must travel through two or more contact interfaces 122 which significantly decreases the total thermal conductivity between the tubes 102, 104. Accordingly, the detached spacer(s) 108 provides heat shielding by reducing thermal energy transfer between the first and second hollow tubes 102, 104.

More specifically, as shown generally in the figures, the fuel nozzle 100 may include a plurality of spacers 108 configured within the gap 106 between the first and second hollow tubes 102, 104. For example, as shown in FIGS. 3-11, the plurality of spacers 108 may include rolling elements, including but not limited to ball bearings 110. In still further embodiments, any suitable spacer configuration may be used and the present disclosure is not limited to ball bearings 110. Further, as shown in FIGS. 3-6, the plurality of spacers 108 may be configured to substantially fill the gap 106 between the first and second hollow tubes 102, 104. Thus, by substantially filling the gap(s) 106, 116, the spacers 108 may be retained in place by adjacent spacers 108, although individual spacers 108 are not required to be mounted or otherwise secured to the internal walls of the tubes 102, 104.

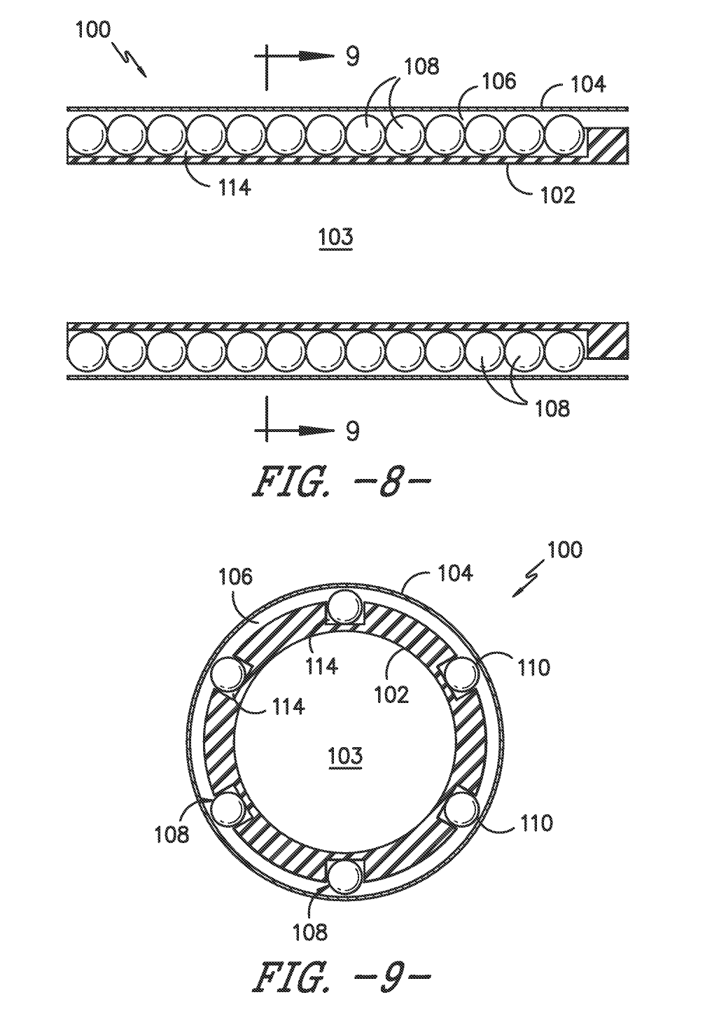

In alternative embodiments, as shown in FIGS. 8 and 9, the detached spacers 102 may be retained within the gap 106 via one or more longitudinally-extending recesses 114 or cavities. For example, as shown, the first hollow tube 102 of the fuel nozzle 100 may include one or more longitudinally-extending recesses 114 so as to retain the detached spacer(s) within the gap 106. As such, the recesses 114 may be configured to receive a portion of the plurality of spacers 108 so as to retain the spacers 108 therein. Thus, in such embodiments, the recesses 114 are configured to retain the spacers 108 within the gap 106 without the spacers 108 being mounted or otherwise secured to the internal walls of the tubes 102, 104.

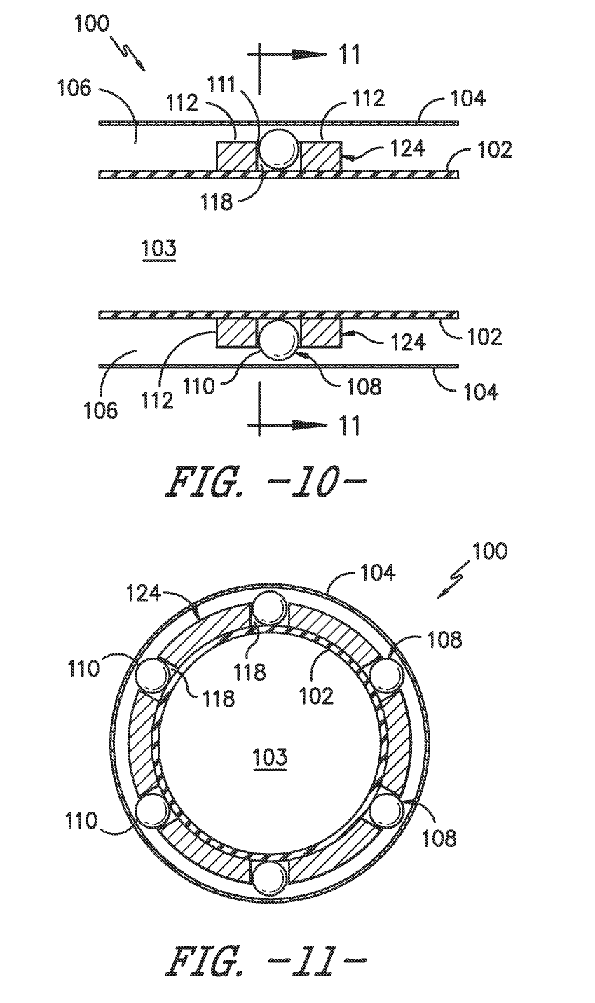

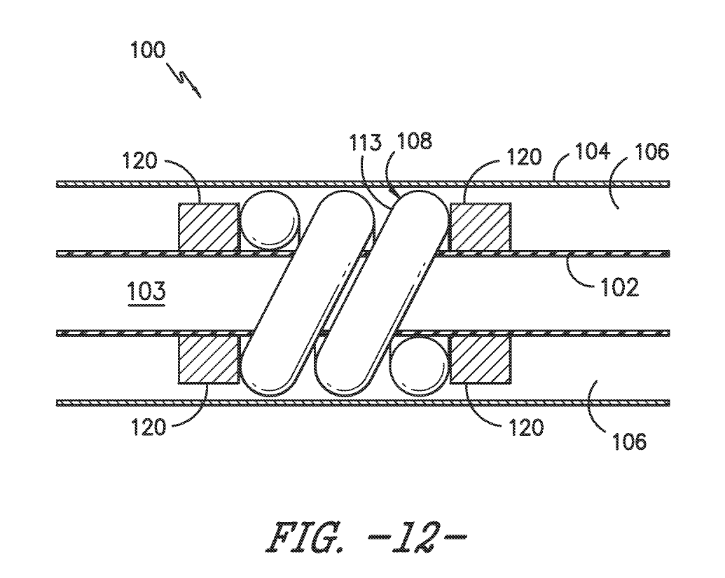

In additional embodiments, as shown in FIGS. 10 and 11, the fuel nozzle 100 may include one or more annular retaining components 124 having one or more openings 118 configured to receive the spacers 108 therein. Thus, each of the opening(s) 118 may be configured to retain at least one of the plurality of spacers 108 in a predetermined location with the fuel nozzle 100. For example, as shown in FIG. 10, the retaining component(s) 124 may include a middle portion 111 and opposing sides 112. The middle portion 111 may include the opening(s) 118, whereas the opposing sides 112 may be mounted or otherwise secured to one of the hollow tubes 102, 104, 105. Thus, the spacer(s) 108 are configured to fit within the opening(s) 118 such that the spacers 108 are retained within the gap 106 but not directly secured or mounted to the hollow tubes 102, 104 so as to minimize heat transfer between the first and second hollow tubes.

Referring now to FIG. 12, the spacer(s) 108 may include a spring 113 and/or a wire in addition to the ball bearings 110 as described above. In such an embodiment, the spring(s) 113 may be retained within the gap 106 via one or more retaining members 120 mounted to one or more of the hollow tubes 102, 104, 105. For example, as shown, two retaining members 120 are mounted on the first hollow tube 102 and the spring 113 is configured therebetween. As such, the spring 113 is free within the gap 106 but retained therein via the retaining members 120 so as to minimize heat transfer between the tubes.

In addition, it should be understood that the detached spacer(s) 108 as described herein are configured to maintain linear separation between the hollow tubes 102, 104, 105. Accordingly, the detached spacer(s) 108 may be configured to transfer mechanical forces within the fuel nozzle 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fuel nozzle for channeling fluid towards a combustion chamber defined within a gas turbine engine, the fuel nozzle comprising:
a first hollow tube comprising a central passageway configured to channel fuel therethrough;
a second hollow tube configured with the first hollow tube and defining a gap therebetween, the second hollow tube at a higher temperature than the first hollow tube; and
at least one detached spacer retained within the gap so as to minimize heat transfer between the first and second hollow tubes.

2. The fuel nozzle of claim 1, wherein the first and second hollow tubes are concentrically aligned.

3. The fuel nozzle of claim 2, wherein the first and second hollow tubes are oriented substantially linearly, the detached spacer configured to maintain linear separation between the first and second hollow tubes.

4. The fuel nozzle of claim 1, wherein the at least one spacer is free within the gap such that the spacer is not joined to the first and second hollow tubes.

5. The fuel nozzle of claim 1, further comprising a plurality of spacers configured within the gap between the first and second hollow tubes.

6. The fuel nozzle of claim 5, wherein the plurality of spacers comprise ball bearings.

7. The fuel nozzle of claim 5, wherein the plurality of spacers fills the gap between the first and second hollow tubes.

8. The fuel nozzle of claim 5, wherein the first hollow tube further comprises one or more longitudinally-extending recesses, each of the recesses configured to receive a portion of the plurality of spacers.

9. The fuel nozzle of claim 5, further comprising an annular retaining component comprising one or more openings, the one or more openings configured to retain at least one of the spacers in a predetermined location.

10. The fuel nozzle of claim 1, wherein the at least one spacer comprises at least one of a spring or a wire.

11. The fuel nozzle of claim 10, wherein the at least one spacer is retained within the gap via one or more retaining members mounted to the first hollow tube.

12. The fuel nozzle of claim 1, further comprising a third hollow tube concentrically aligned with the first and second hollow tubes.

13. A fuel nozzle for channeling fluid towards a combustion chamber defined within a gas turbine engine, the fuel nozzle comprising:
a central hollow tube comprising a central passageway configured to channel fuel therethrough;
a secondary hollow tube concentrically aligned with the central hollow tube and defining a first gap therebetween, the secondary hollow tube at a higher temperature than the central hollow tube;
an outer hollow tube concentrically aligned with the secondary hollow tube and defining a second gap therebetween; and
at least one detached spacer retained within at least one of the first or second gaps so as to minimize heat transfer between the hollow tubes.

14. A combustor assembly for use with a gas turbine engine, the combustor assembly comprising:
a combustion chamber;
a fuel nozzle coupled with the combustion chamber, the fuel nozzle comprising:
a first hollow tube comprising a central passageway configured to channel fuel therethrough to the combustion chamber,
a second hollow tube concentrically aligned with the first hollow tube and defining a gap therebetween, the second flow channel at a higher temperature than the first flow channel, and
at least one detached spacer retained within the gap so as to minimize heat transfer between the first and second hollow tubes.

15. The combustor assembly of claim 14, wherein the at least one spacer comprises at least one of a ball bearing, a spring, or a wire.

16. The combustor assembly of claim 15, further comprising a plurality of detached spacers configured within the gap between the first and second hollow tubes.

17. The combustor assembly of claim 16, wherein the plurality of spacers fills the gap between the first and second hollow tubes.

18. The combustor assembly of claim 16, wherein the first hollow tube further comprises one or more longitudinally-extending recesses, each of the recesses configured to receive a portion of the plurality of spacers.

19. The combustor assembly of claim 14, further comprising an annular retaining component comprising one or more openings, the one or more openings configured to retain at least one of the detached spacers in a predetermined location.

20. The combustor assembly of claim 14, wherein the at least one detached spacer is retained within the gap via one or more retaining members mounted to the first hollow tube.
